(19) United States
(12) Patent Application Publication
(10) Pub. No.: US 2007/0115390 A1
(43) Pub. Date: May 24, 2007

(54) Television broadcast receiving apparatus, door phone apparatus, and interphone system

(75) Inventors: Hiroyuki Makara, Echizen-city (JP); Hiroaki Shimada, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/599,348

(22) Filed: Nov. 15, 2006

(30) Foreign Application Priority Data
Nov. 24, 2005 (JP) 2005-339444

(51) Int. Cl. H04N 7/00; H04N 5/44

(52) U.S. Cl. 348/552; 348/553

(57) ABSTRACT

Disclosed is an interphone system that uses a home-use television broadcast receiving apparatus capable of receiving instructions for dealing with a visitor. According to the invention, a television includes a sending/receiving section for sending and receiving signals to and from a door phone apparatus, a storage section in which response information is stored as text data, and an audio synthesis processor which converts text data into an audio signal. An audio signal based on response information (e.g., “Please come in”) selected with the television is sent to the door phone apparatus and outputted from a door phone slave unit installed at the entrance of a house. Thus, it becomes possible to deal with a visitor by operating the television.

The present application is based on and claims priority of Japanese patent application No. 2005-339444 filed on Nov. 24, 2005, the entire contents of which are hereby incorporated by reference.

### BACKGROUND OF THE INVENTION

1. Field of the Invention

The present invention relates to an interphone system, and specifically to an interphone system that uses a television broadcast receiving apparatus.

2. Description of the Related Art

There has been widely used an interphone system which enables a resident inside a house to hold a conversation with a visitor outside the house by installing a door phone slave unit at the entrance of the house and installing a door phone master unit in the house. Further, there has been used a video interphone system which allows a door phone master unit to display video from a camera provide data door phone slave unit. Conventional techniques that enable home-use television sets to be used in these interphone systems are disclosed in Japanese Patent Application Laid-Open No. 6-113025 (patent document 1), Japanese Patent Application Laid-Open No. 2001-309364 (patent document 2), and the like.

### SUMMARY OF THE INVENTION

The conventional techniques disclosed in the above-mentioned patent documents basically only allows video from a camera provided at a door phone slave unit to be displayed on a home-use television set, but does not make it possible to deal with a visitor with the home-use television set.

In view of the foregoing, it is an object of the present invention to provide an interphone system that uses a home-use television broadcast receiving apparatus capable of receiving instructions for dealing with a visitor.

According to a first aspect of the invention, there is provided a television broadcast receiving apparatus which receives broadcast signals of different frequencies, including an input section capable of receiving an audio signal and/or a video signal from a door phone apparatus including a door phone slave unit and a door phone master unit; an audio processing section and/or a video display processing section; a speaker; a display section; an output section capable of sending response information to the door phone apparatus; and a storage section which stores response information inputted in advance or by a user, wherein the audio processing section or the video display processing section allows the speaker or the display section to output audio or video at the time of receiving an audio signal or a video signal from the door phone apparatus, and the output section sends the response information stored in the storage section in response to the audio signal or the video signal from the door phone apparatus.

With this configuration, the television broadcast receiving apparatus can output an audio signal or a video signal received from the door phone apparatus and send the response information. “Audio signals from the door phone apparatus” include a call tone signal generated by a call function provided in the door phone slave unit as well as a visitor's voice obtained by the door phone slave unit.

According to a second aspect of the invention, there is provided a television broadcast receiving apparatus of the first aspect, further including an operating section and an audio synthesis processing section, wherein the response information is set by the user operating the operating section, acquired as text data and stored in the storage section; and the response information that is sent as a response from the output section to the door phone apparatus is an audio signal into which the text data is converted by the audio synthesis processing section.

With this configuration, the audio synthesis processing section converts text data (response information) set by the user into an audio signal, which is sent to the door phone apparatus.

According to a third aspect of the invention, there is provided a door phone apparatus including a door phone slave unit and a door phone master unit, including a sending section capable of sending an audio signal or a video signal from the door phone slave unit having a microphone or a microphone and a camera to a television broadcast receiving apparatus of the first or second aspect; and a receiving section capable of receiving response information sent from the television broadcast receiving apparatus, wherein when the receiving section receives response information from the television broadcast receiving apparatus, a speaker provided in the door phone slave unit outputs audio corresponding to the response information.

With this configuration, the door phone apparatus sends an audio signal (including a call tone signal) or a video signal generated by a visitor operating the door phone slave unit to the television broadcast receiving apparatus, and the door phone slave unit outputs audio based on the response information received from the television broadcast receiving apparatus.

According to a fourth aspect of the invention, there is provided an interphone system including a television broadcast receiving apparatus of the first or second aspect and a door phone apparatus of the third aspect, wherein an input section and an output section provided in the television broadcast receiving apparatus are respectively connected with a sending section and a receiving section provided in the door phone apparatus through wire or by radio; when there is an output of an audio signal or a video signal from a door phone slave unit, the door phone apparatus sends the audio signal or the video signal to the television broadcast receiving apparatus and the television broadcast receiving apparatus outputs audio or video based on the received audio signal or video signal; and when there is a response instruction provided from a user to the television broadcast receiving apparatus, the television broadcast receiving apparatus sends response information to the door phone apparatus and the door phone apparatus outputs audio based on the received response information through a speaker provided in the door phone slave unit.

With this configuration, the door phone apparatus sends an audio signal (including a call tone signal) or a video signal generated by a visitor operating the door phone slave unit to the television broadcast receiving apparatus, the television broadcast receiving apparatus can output audio or video based on the audio signal or the video signal, the user can provide a response instruction to the television broadcast receiving apparatus, the television broadcast receiving apparatus sends response information according to the response instruction to the door phone apparatus, and the door phone slave unit outputs audio based on the response information.

According to a fifth aspect of the invention, there is provided a door phone apparatus including a door phone slave unit and a door phone master unit, including a sending section capable of sending an audio signal or a video signal from the door phone slave unit having a microphone or a microphone and a camera to a television broadcast receiving apparatus of the first aspect; a receiving section capable of receiving response information sent from the television broadcast receiving apparatus; and an audio synthesis processing section, wherein when the receiving section receives response information from the television broadcast receiving apparatus, the audio synthesis processing section generates an audio signal based on the response information and a speaker provided in the door phone slave unit outputs audio corresponding to the audio signal.

With this configuration, the audio synthesis processing section generates an audio signal based on the response information sent from the television broadcast receiving apparatus, and the door phone slave unit outputs audio based on the audio signal.

According to a sixth aspect of the invention, there is provided an interphone system including a television broadcast receiving apparatus of the first aspect and a door phone apparatus of the fifth aspect, wherein response information stored in a storage section of the television broadcast receiving apparatus is text data; an input section and an output section provided in the television broadcast receiving apparatus are respectively connected with a sending section and a receiving section provided in the door phone apparatus through wire or by radio; when there is an output of an audio signal or a video signal from a door phone slave unit, the door phone apparatus sends the audio signal or the video signal to the television broadcast receiving apparatus and the television broadcast receiving apparatus outputs audio or video based on the received audio signal or video signal; and when there is a response instruction provided from a user to the television broadcast receiving apparatus, the television broadcast receiving apparatus sends text data that is the response information to the door phone apparatus and the door phone apparatus generates an audio signal based on the received text data through the audio synthesis processing section and outputs audio based on the audio signal through a speaker provided in the door phone slave unit.

With this configuration, the door phone apparatus sends an audio signal (including a call tone signal) or a video signal generated by a visitor operating the door phone slave unit to the television broadcast receiving apparatus, the television broadcast receiving apparatus can output audio or video based on the audio signal or the video signal, the user can provide a response instruction to the television broadcast receiving apparatus, the television broadcast receiving apparatus sends text data that is response information according to the response instruction to the door phone apparatus, the audio synthesis processing section generates an audio signal based on the text data, and the door phone slave unit outputs audio based on the audio signal.

According to a seventh aspect of the invention, there is provided a door phone apparatus including a door phone slave unit and a door phone master unit, including an audio synthesis processing section; a storage section which stores response information inputted in advance or by a user; and a data input-output section capable of inputting and outputting data from and to a television broadcast receiving apparatus, wherein when there is an output of an audio signal or a video signal from the door phone slave unit, the data input-output section sends the audio signal or the video signal and a response instruction request; and when there is an instruction from the television broadcast receiving apparatus in response to the response instruction request, the audio synthesis processing section generates an audio signal based on the response information according to the instruction and a speaker provided in the door phone slave unit outputs audio corresponding to the audio signal.

With this configuration, when an audio signal (including a call tone signal) or a video signal is generated by a visitor operating the door phone slave unit, the door phone apparatus sends the audio signal or the video signal and a response instruction request to the television broadcast receiving apparatus. When there is an instruction from the television broadcast receiving apparatus in response to the response instruction request, the audio synthesis processing section generates an audio signal based on the response information stored in the storage section according to the instruction, and the door phone slave unit outputs audio based on the audio signal.

According to an eighth aspect of the invention, there is provided a television broadcast receiving apparatus which receives broadcast signals of different frequencies, including a data input-output section capable of inputting and outputting data from and to a door phone apparatus of the seventh aspect; an audio processing section and/or a video display processing section; a speaker; a display section; and an operating section, wherein the audio processing section or the video display processing section allows the speaker or the display section to output audio or video at the time of receiving an audio signal or a video signal from the door phone apparatus, the video display processing section displays a response instruction request on the display section at the time of receiving the response instruction request, and when there is an instruction provided from a user to the operating section in response thereto, the data input-output section sends the instruction to the door phone apparatus.

With this configuration, when there is a response instruction request from the door phone apparatus, the television broadcast receiving apparatus displays the response instruction request on the display section and waits for the user's instruction. When there is an instruction provided from the user, the television broadcast receiving apparatus sends the instruction to the door phone apparatus.

According to a ninth aspect of the invention, there is provided an interphone system including a door phone apparatus of the seventh aspect and a television broadcast receiving apparatus of the eighth aspect, wherein a data input-output section provided in the door phone apparatus is connected with a data input-output section provided in the television broadcast receiving apparatus through wire or by radio; when there is an output of an audio signal or a video signal from a door phone slave unit, the data input-output section sends the audio signal or the video signal and a response instruction request and the television broadcast receiving apparatus outputs audio or video based on the received audio signal or video signal and displays the response instruction request on the display section; and when there is an instruction provided from a user in response thereto, the television broadcast receiving apparatus sends the instruction to the door phone apparatus, and the door phone apparatus generates an audio signal based on response information through the audio synthesis processing section according to the instruction and outputs audio based on the audio signal through a speaker provided in the door phone slave unit.

With this configuration, when an audio signal (including a call tone signal) or a video signal is generated by a visitor operating the door phone slave unit, the door phone apparatus sends the audio signal or the video signal and a response instruction request to the television broadcast receiving apparatus, and the television broadcast receiving apparatus outputs audio or video based on the audio signal or the video signal and displays the response instruction request on the display section. When there is an instruction provided from the user to the television broadcast receiving apparatus in response thereto, the television broadcast receiving apparatus sends the instruction to the door phone apparatus, and the door phone apparatus generates an audio signal based on response information stored in the storage section through the audio synthesis processing section according to the received instruction and outputs audio based on the audio signal through the door phone slave unit.

As described, the first aspect of the invention provides the television broadcast receiving apparatus which receives broadcast signals of different frequencies, including an input section capable of receiving an audio signal and/or a video signal from a door phone apparatus including a door phone slave unit and a door phone master unit; an audio processing section and/or a video display processing section; a speaker; a display section; an output section capable of sending response information to the door phone apparatus; and a storage section which stores response information inputted in advance or by a user, wherein the audio processing section or the video display processing section allows the speaker or the display section to output audio or video at the time of receiving an audio signal or a video signal from the door phone apparatus, and the output section sends the response information stored in the storage section in response to the audio signal or the video signal from the door phone apparatus. According to the television broadcast receiving apparatus of the first aspect of the invention, the television broadcast receiving apparatus can output an audio signal or a video signal received from the door phone apparatus and send the response information. Thereby, the user can respond to the visitor by operating the television broadcast receiving apparatus, thus offering excellent convenience to the user.

The second aspect of the invention provides the television broadcast receiving apparatus of the first aspect, further including an operating section and an audio synthesis processing section, wherein the response information is set by the user operating the operating section, acquired as text data and stored in the storage section; and the response information that is sent as a response from the output section to the door phone apparatus is an audio signal into which the text data is converted by the audio synthesis processing section. According to the television broadcast receiving apparatus of the second aspect of the invention, the audio synthesis processing section converts text data (response information) set by the user into an audio signal, which is sent to the door phone apparatus. For example, the user sets a response such as “May I ask the purpose of your visit?” in text. The audio synthesis processing section converts it into the audio signal of “May I ask the purpose of your visit?”, which is sent to the door phone apparatus, thus offering excellent convenience to the user.

The fourth aspect of the invention provides the interphone system including a television broadcast receiving apparatus of the first or second aspect and a door phone apparatus of the third aspect, wherein an input section and an output section provided in the television broadcast receiving apparatus are respectively connected with a sending section and a receiving section provided in the door phone apparatus through wire or by radio; when there is an output of an audio signal or a video signal from a door phone slave unit, the door phone apparatus sends the audio signal or the video signal to the television broadcast receiving apparatus and the television broadcast receiving apparatus outputs audio or video based on the received audio signal or video signal; and when there is a response instruction provided from a user to the television broadcast receiving apparatus, the television broadcast receiving apparatus sends response information to the door phone apparatus and the door phone apparatus outputs audio based on the received response information through a speaker provided in the door phone slave unit. According to the interphone system of the fourth aspect of the invention, the door phone apparatus sends an audio signal or a video signal generated by a visitor operating the door phone slave unit to the television broadcast receiving apparatus, the television broadcast receiving apparatus can output audio or video based on the audio signal or the video signal, the user can provide a response instruction to the television broadcast receiving apparatus, the television broadcast receiving apparatus sends response information according to the response instruction to the door phone apparatus, and the door phone slave unit outputs audio based on the response information. That is, it becomes possible to deal with the visitor with the television apparatus which is relatively frequently used in an ordinary household, thus offering excellent convenience to the user.

### BRIEF DESCRIPTION OF THE DRAWINGS

Embodiments of the present invention will be described in detail based on the following figures, wherein:

FIG. 1 is a block diagram showing the outline of a configuration relating to the present invention of a television broadcast receiving apparatus;

FIG. 2 is a block diagram showing the outline of a configuration relating to the invention of a door phone master unit and a door phone slave unit;

FIG. 3 is a flowchart showing the outline of operation relating to the invention of the door phone slave unit;

FIG. 4 is a flowchart showing the outline of operation relating to the invention of the door phone master unit;

FIG. 5 is a flowchart showing the outline of operation relating to response information setting processing of the television broadcast receiving apparatus;

FIG. 6 is a flowchart showing the outline of operation relating to the invention of the television broadcast receiving apparatus;

FIG. 7 is an illustration showing an example of a display screen (response information setting screen);

FIG. 8 is an illustration showing an example of a display screen (response message selection screen);

FIG. 9 is a block diagram showing the outline of a configuration of a wireless handset;

FIG. 10 is a block diagram showing the outline of a configuration relating to the invention of a television broadcast receiving apparatus according to a second embodiment;

FIG. 11 is a block diagram showing the outline of a configuration relating to the invention of a door phone apparatus according to the second embodiment;

FIG. 12 is a flowchart showing the outline of operation relating to the invention of the door phone apparatus according to the second embodiment;

FIG. 13 is a flowchart showing the outline of operation relating to the invention of the television broadcast receiving apparatus according to the second embodiment;

FIG. 14 is a block diagram showing the outline of a configuration relating to the invention of a television broadcast receiving apparatus according to a third embodiment;

FIG. 15 is a block diagram showing the outline of a configuration relating to the invention of a door phone apparatus according to the third embodiment;

FIG. 16 is a flowchart showing the outline of operation relating to the invention of the door phone apparatus according to the third embodiment; and

FIG. 17 is an illustration showing an example of a display screen (response message and video selection screen).

### DESCRIPTION OF THE PREFERRED EMBODIMENTS

Specific embodiments of the present invention will be described with reference to the attached drawings. The embodiments below are merely examples for implementing the invention and not intend to limit the invention.

### First Embodiment

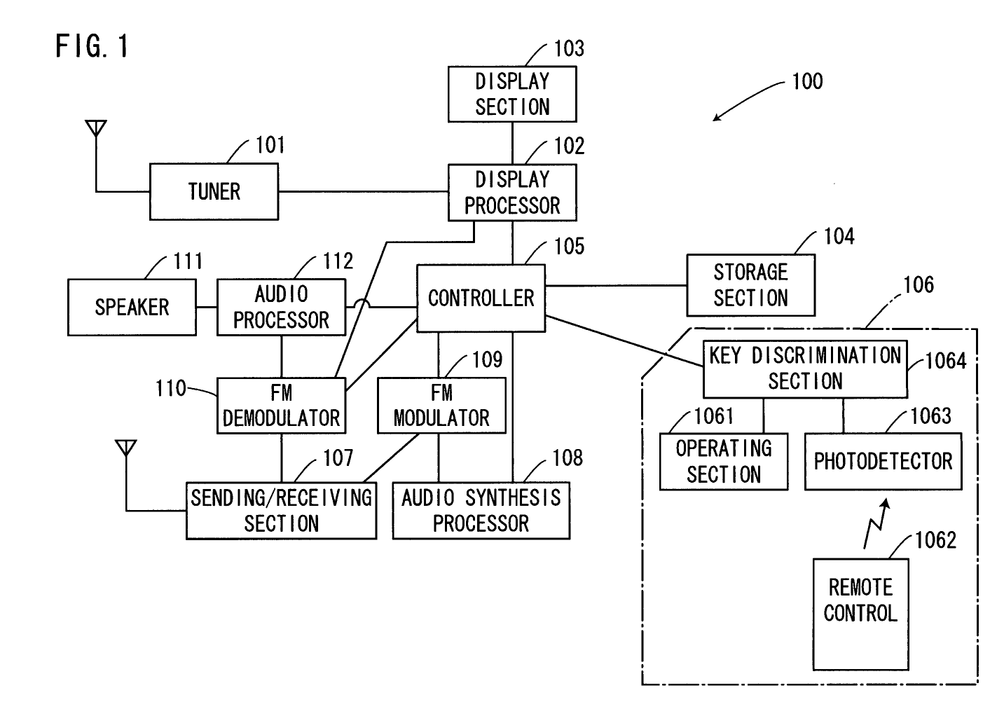

FIG. 1 is a block diagram showing the outline of a configuration relating to the invention of a television broadcast receiving apparatus (hereinafter, simply referred to as a television) constituting an interphone system according to this embodiment.

As shown in FIG. 1, a television 100 of this embodiment includes a tuner 101 which receives broadcast signals of different frequencies, a display processor 102 which performs processing (such as generating RGB video signals used for displaying video on a display section 103) on signals inputted from the tuner 101, a display section 103, a storage section 104, a controller 105 which controls the entire television 100, an operating section 106 which is an input interface for a user, a speaker 111, an audio processor 112 which performs processing (such as amplification) on an audio signal, a sending/receiving section 107 for sending and receiving signals to and from a door phone apparatus by radio waves, an FM modulator 109 which performs FM modulation, an FM demodulator 110 which performs FM demodulation, and an audio synthesis processor 108 which generates an audio signal from text data or the like. The operating section 106 includes an operating section proper 1061, a remote control 1062, a photodetector 1063 which receives signals from the remote control 1062, and a key discrimination section 1064 which discriminates the contents of a signal from the operating section proper 1061 or the photodetector 1063.

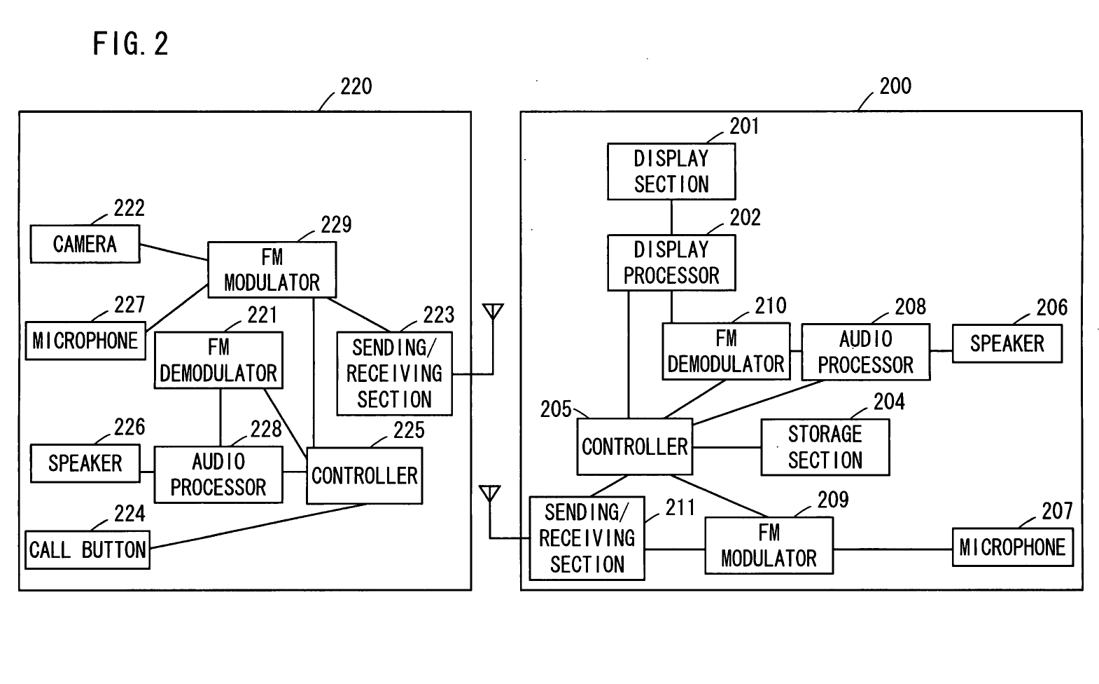

FIG. 2 is a block diagram showing the outline of a configuration relating to the invention of a door phone apparatus constituting the interphone system according to this embodiment. As shown in FIG. 2, the door phone apparatus of this embodiment includes a door phone master unit 200 which is installed in a house and a door phone slave unit 220 which is installed at the entrance of the house.

The door phone master unit 200 includes a display section 201, a display processor 202, a sending/receiving section 211 for sending and receiving signals to and from the door phone slave unit 220 by radio waves, a storage section 204, a controller 205 which controls the entire apparatus, a speaker 206, a microphone 207, an audio processor 208, an FM modulator 209 which performs FM modulation, and an FM demodulator 210 which performs FM demodulation.

The door phone slave unit 220 includes a sending/receiving section 223 for sending and receiving signals to and from the door phone master unit 200 (and the television 100) by radio waves, a controller 225, a speaker 226, a microphone 227, an audio processor 228, an FM modulator 229, an FM demodulator 221, a camera 222, and a call button 224 with which a visitor informs a resident of his/her visit.

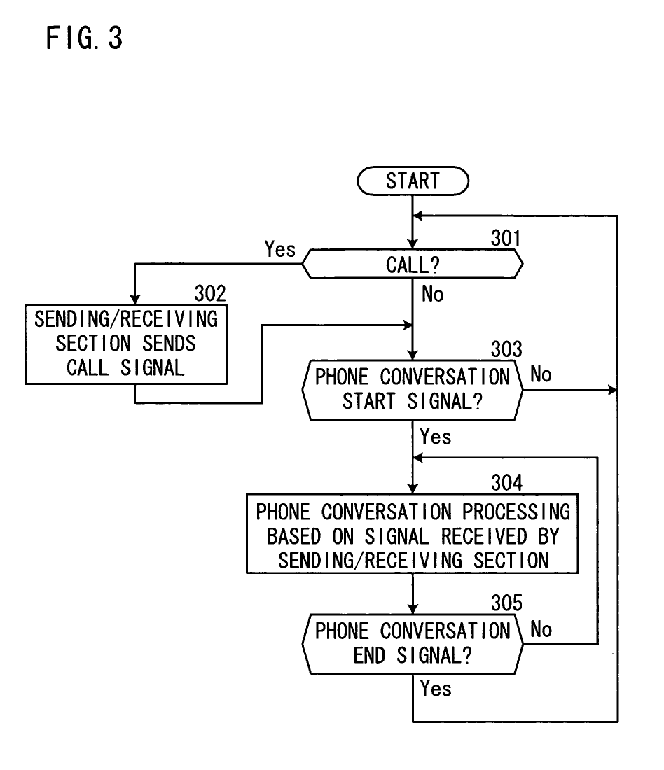

The outline of operation relating to the invention of the interphone system having the above-mentioned configuration will be described with reference to FIGS. 3 to 6.

FIG. 3 is a flowchart showing the outline of operation relating to the invention of the door phone slave unit 220. When a visitor presses the call button 224 of the door phone slave unit 220 installed at the entrance, a “call” is originated (step 301) and a call signal is sent from the sending/receiving section 223 (step 302). In step 303, it is determined whether or not the sending/receiving section 223 has received a “phone conversation start signal”. If the sending/receiving section 223 has received a “phone conversation start signal”, the process proceeds to step 304. The “phone conversation start signal” refers to a signal that is generated when, in order to start a phone conversation with the visitor, a resident operates the door phone apparatus, for example, lifts a handset (not shown) provided at the door phone master unit 200. The phone conversation start signal is sent from the door phone master unit 200 or the television 100, as described below.

In step 304, based on the signal received by the sending/receiving section 223, the door phone slave unit 220 and the door phone master unit 200 (or the television 100) perform phone conversation processing between themselves (i.e., between the visitor and the resident). The phone conversation processing is performed as follows. The FM modulator 229 modulates a video signal obtained by the camera 222 of the door phone slave unit 220 and an audio signal obtained by the microphone 227, and the sending/receiving section 223 sends the modulated video signal and audio signal. The FM demodulator 221 demodulates a signal received by the sending/receiving section 223, and the audio processor 228 allows the speaker 226 to output audio corresponding to the demodulated audio signal.

Instep 305, it is determined whether or not there is a “phone conversation end signal”. If there is a “phone conversation end signal”, the process returns to step 301 for repetition of the above-described steps. The “phone conversation end signal” refers to a signal that is generated when, in order to end the phone conversation with the visitor, the resident operates the door phone apparatus, for example, puts down the handset provided at the door phone master unit 200.

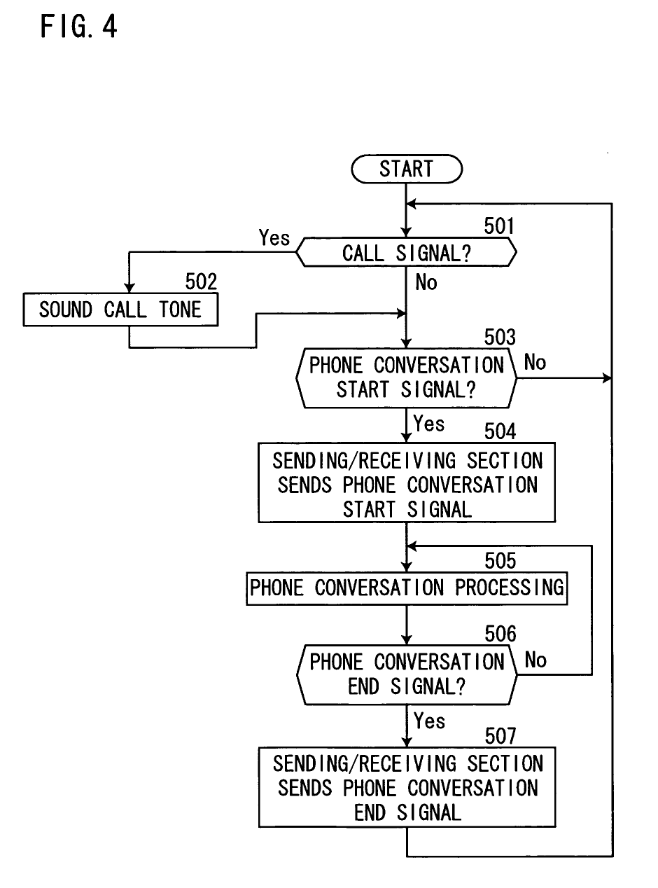

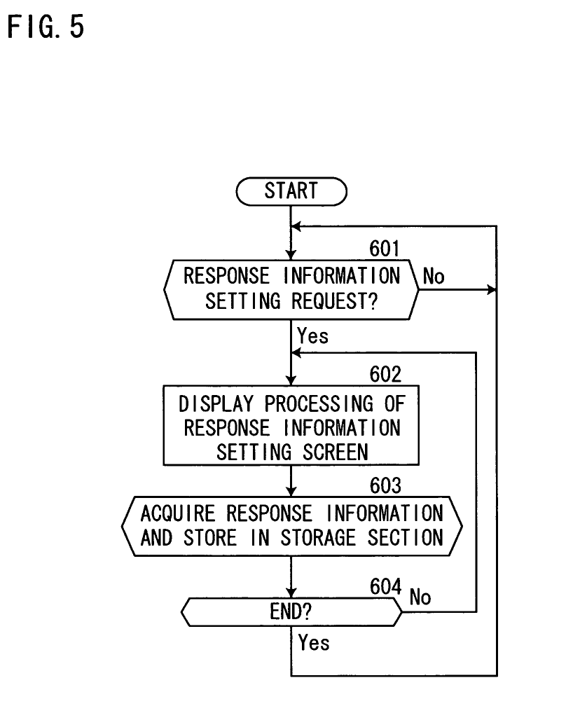

FIG. 4 is a flowchart showing the outline of operation relating to the invention of the door phone master unit 200. When the sending/receiving section 211 receives a “call signal” from the door phone slave unit 220 (step 501), the speaker 206 outputs a call tone such as “ding-dong” (step 502). In step 503, it is determined whether or not there is a “phone conversation start signal” (a signal that is generated when, in order to start a phone conversation with the visitor, the resident operates the door phone master unit 200). If there is a “phone conversation start signal”, the “phone conversation start signal” is sent from the sending/receiving section 211 to the door phone slave unit 220 (step 504). Thereby, as shown in step 303 in FIG. 3, the process in the door phone slave unit 220 proceeds to step 304, where phone conversation processing is started. Concurrently, the phone conversation processing is started in the door phone master unit 200 as well (step 505 in FIG. 5). The phone conversation processing is performed as follows. The FM demodulator 210 demodulates a signal received by the sending/receiving section 211, the display processor 202 allows the display section 201 to display video corresponding to a video signal, and the audio processor 208 allows the speaker 206 to output audio corresponding to an audio signal. The FM modulator 209 modulates an audio signal obtained by the microphone 207 of the door phone master unit 200, and the sending/receiving section 211 sends the modulated audio signal. In this manner, the phone conversation processing is performed between the door phone slave unit 220 and the door phone master unit 200.

In step 506, it is determined whether or not there is a “phone conversation end signal” (a signal that is generated when, in order to end the phone conversation with the visitor, the resident operates the door phone master unit 200). If there is a “phone conversation end signal”, the “phone conversation end signal” is sent from the sending/receiving section 211 to the door phone slave unit 220 (step 507), and the process returns to step 501 for repetition of the above-described steps.

In the interphone system according to this embodiment, the television 100 is used with the above-described door phone apparatus so as to deal with a visitor. Since the television 100 sends and receives signals to and from the door phone slave unit 220 by radio waves, a radio frequency used between the door phone slave unit 220 and the door phone master unit 200 is set in the television 100 in advance or by a user.

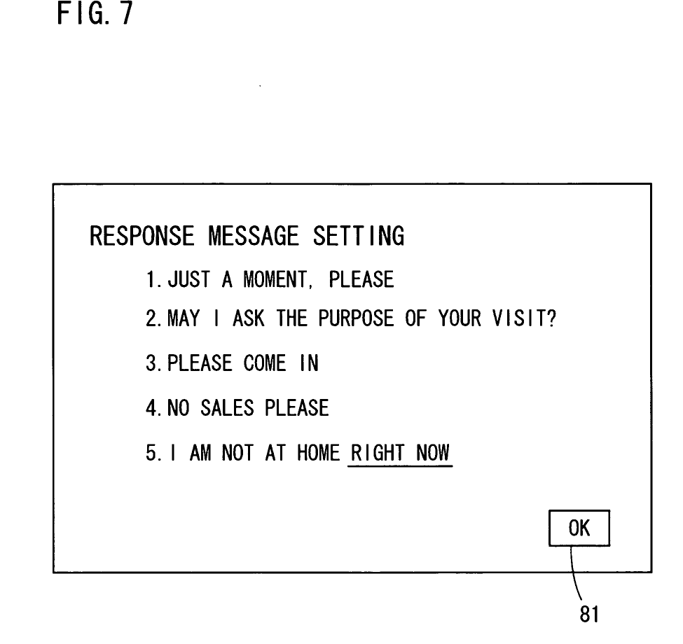

FIG. 5 is a flowchart showing the outline of “response information” setting processing of the television 100. In step 601, the television 100 waits for a “response information” setting request from a user. If there is a “response information” setting request, the television 100 displays a response information setting screen shown in FIG. 7 (step 602), acquires “response information” and stores it in the storage section 104 (step 603), and ends the processing at the time of input of an OK button 81 (step 604). The setting processing is performed as follows. While the controller 105 having an OSD signal generation function and the display processor 102 display a setting screen on the display section 103 (changing a display screen in accordance with a user's input), the key discrimination section 1064 and the controller 105 determines input information from the user through the remote control 1062 or the operating section 1061 to acquire each setting information (response information inputted as text data). The same concept applies to screen display processing below and the determination of the user's operation.

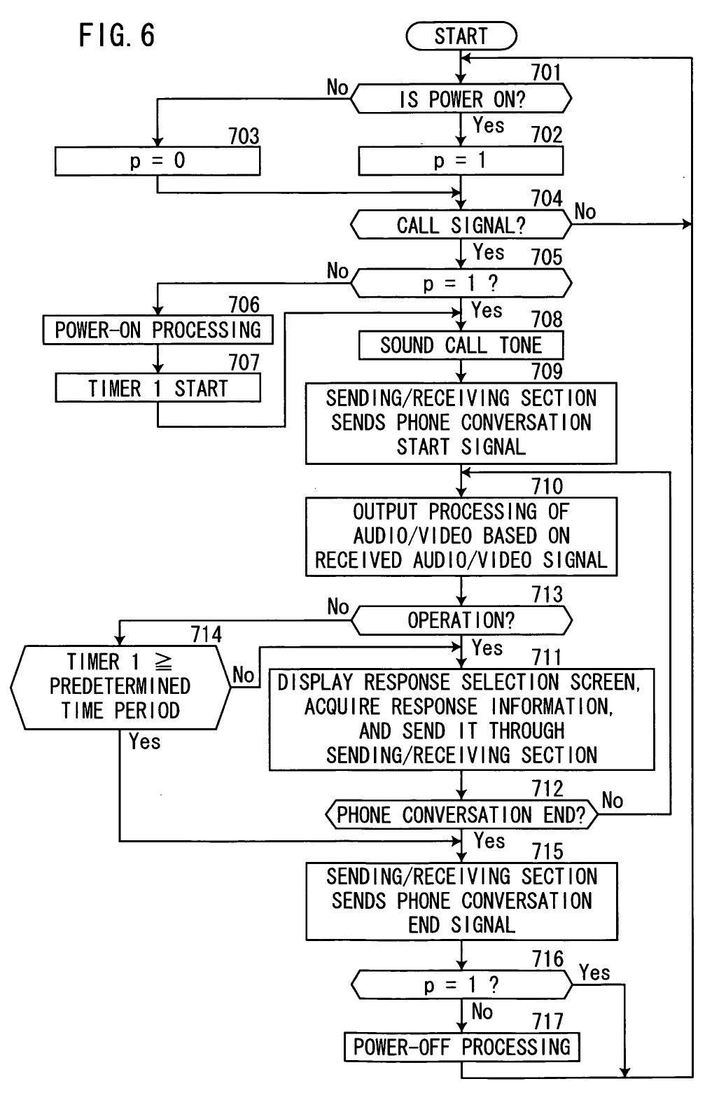

FIG. 6 is a flowchart showing the outline of operation relating to the invention of the television 100. In step 701, it is determined whether the power of the television 100 is ON or OFF. If the television is in the ON state, the controller 105 substitutes 1 for a variable p (step 702) and stores it in the storage section 104. If the television is in the OFF state, the controller 105 substitutes 0 for the variable p (step 703) and stores it in the storage section 104. The expression “the television is in the OFF state” does not indicate that the entire television is completely electrically in the OFF state, but indicates that power is not supplied to a plurality of portions in the television but a part of the television (e.g., the controller) is alive.

In the subsequent step 704, it is determined whether or not the sending/receiving section 107 has received a “call signal” from the door phone slave unit 220. If the sending/receiving section 107 has received a “call signal”, it is determined whether p stored in the storage section 104 is 1 (step 705). If p is 0 (i.e., the power is OFF), the controller 105 performs power-on processing (step 706) and starts a timer 1 of the controller 105 (step 707). After that, the controller 105 and the audio processor 112 allows the speaker 111 to output a call tone such as “ding-dong” (step 708).

In step 709, the sending/receiving section 107 sends a “phone conversation start signal” to the door phone slave unit 220. Thereby, as shown in step 303 in FIG. 3, the process in the door phone slave unit 220 proceeds to step 304, where phone conversation processing is started so that an audio signal and a video signal obtained by the door phone slave unit 220 are sent from the sending/receiving section 223. At the other end, in the television 100, the sending/receiving section 107 receives the audio signal and the video signal, the FM demodulator 110 demodulates the audio signal and the video signal, the display processor 102 allows the display section 103 to display video corresponding to the video signal, and the audio processor 112 allows the speaker 111 to output audio corresponding to the audio signal (step 710). In the case where the television is in use (e.g., the user is viewing a broadcast program) at the time of displaying video on the display section, a sub-screen may be used to display the video from the door phone apparatus.

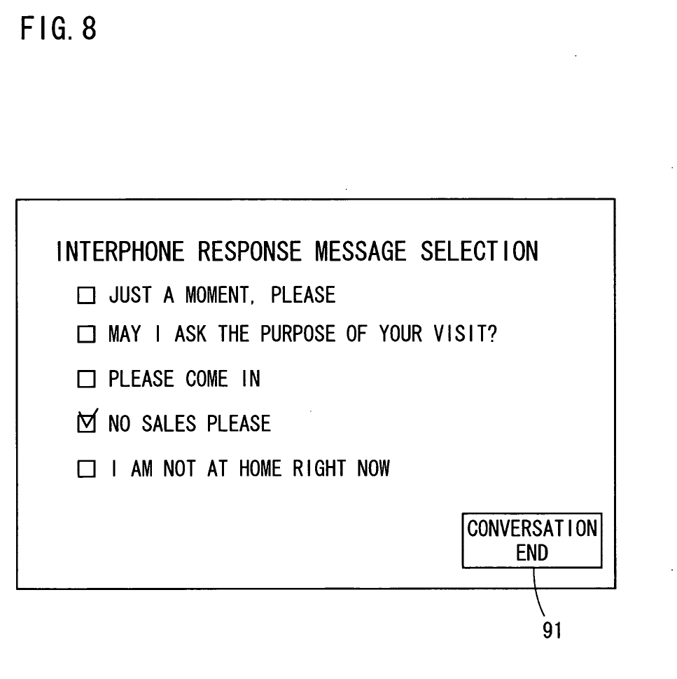

In step 711, the television displays a response selection screen shown in FIG. 8 on the display section 103 by superimposing it on the video from the door phone apparatus, and acquires response information selected by the user. The audio synthesis processor 108 generates an audio signal from the response information (text data), the FM modulator 109 modulates the audio signal, and the sending/receiving section 107 sends the modulated audio signal to the door phone slave unit 220. At the other end, the door phone slave unit 220 demodulates the received signal to output audio through the speaker 226. Further, the response selection screen may be displayed at the same time as video from the door phone apparatus. Alternatively, the response selection screen may be displayed in response to a request for displaying a response selection screen from the user.

In step 712, it is determined whether or not the phone conversation ends (the presence or absence of input of a phone conversation end button 91). If the phone conversation ends, the television sends a “phone conversation end signal” through the sending/receiving section 107 to the door phone slave unit 220 and ends the output of video and audio from the door phone apparatus (step 715). Further, it is determined whether p stored in the storage section 104 is 1 (step 716). If p is 0 (i.e., the power is OFF at the time of receiving the call signal (step 704)), the controller 105 performs power-off processing (step 717) and returns to step 701 for repetition of the above-described steps. As shown by steps 713 to 714, if no operation is performed for a predetermined period of time (which is set in advance or by the user and stored in the storage section 104) after receiving the call signal, the television ends the output of video and audio from the door phone apparatus.

In the processing (flowchart of FIG. 6) of the television 100 according to this embodiment, upon receiving a “call signal” from the door phone apparatus, the television 100 always sends a “phone conversation start signal” to the door phone apparatus (step 709). However, in this processing, a “function of dealing with the door phone apparatus by the television” may be activated or deactivated according to the user's setting. For example, the television may be set such that the “function of dealing with the door phone apparatus by the television” is activated only when the power of the television is ON. Further, the television may send a “phone conversation start signal” in response to an instruction from the user.

As described above, according to the interphone system of this embodiment, the television 100 can receive an audio signal or a video signal generated by the visitor operating the door phone slave unit 220 and can output audio or video based on the audio signal or the video signal. In response thereto, the user can provide a response instruction by operating the remote control or the like of the television 100 so that the door phone slave unit 220 can output audio based on the response information. Thus, in such a case where the user has a visitor when watching television, it is not necessary to take the trouble to go to the place of the door phone master unit 200 to respond to the visitor, and it is possible to deal with the visitor by only operating the remote control or the like of the television 100, thus offering excellent convenience to the user. Further, the audio synthesis processor 108 converts text data (response information) set by the user into an audio signal, which is sent to the door phone apparatus, thereby enabling the door phone slave unit 220 to output mechanical voice such as “No sales please”. Therefore, in such a case where the visitor is a salesman, this system can be expected to serve as a deterrent against persistent solicitation. Due to mechanical voice, the user can pretend to be out by giving a response such as “I am not at home right now”.

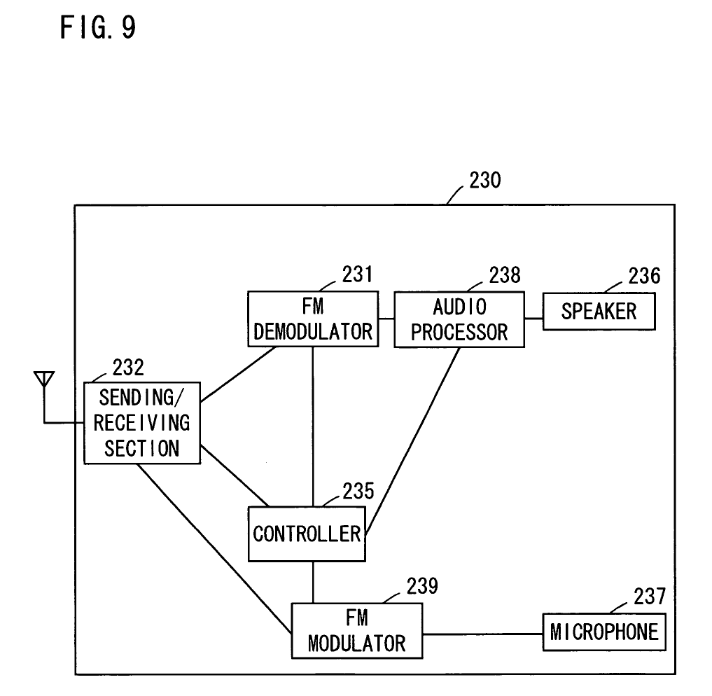

According to the configuration of the interphone system of this embodiment, the television 100 can send and receive radio waves emitted from the door phone apparatus (radio waves used between the door phone master unit 200 and the door phone slave unit 220). Therefore, by using the television 100, it is possible to use an existing apparatus as the door phone apparatus, thus realizing the interphone system of the invention at low cost. In this embodiment, the television 100 is set so as to send and receive radio waves used between the door phone master unit 200 and the door phone slave unit 220. However, in the case where the door phone apparatus includes a wireless handset and the door phone master unit is connected with the door phone slave unit through wire and connected with the wireless handset by radio (FIG. 9 is a block diagram showing the outline of a configuration of the wireless handset), the television 100 may be set so as to send and receive radio waves used between the door phone master unit and the wireless handset (the same concept applies in this case).

In this embodiment, the television 100 side includes the audio synthesis processor, and converts response information (text data) into an audio signal, which is sent to the door phone apparatus. However, the door phone apparatus side may include the audio synthesis processor. Thereby, the television 100 sends response information (text data) to the door phone apparatus, and the door phone apparatus side converts response information (text data) into an audio signal. Further, in this embodiment, response information is set as text data. However, response information as audio information may be stored in the storage section in advance or by the user with a microphone, thereby negating the need for the audio synthesis processor.

In addition, by assigning priority to response information stored in the storage section, response information may be displayed on a response message selection screen in the priority order. Further, by counting the number of times response information is selected, a higher priority may be given to frequently used response information. Furthermore, by selecting response information beforehand, the response information may be automatically sent to the door phone apparatus at the time of receiving a call signal from the door phone apparatus. Thereby, it is possible to use it as an answering machine message.

### Second Embodiment

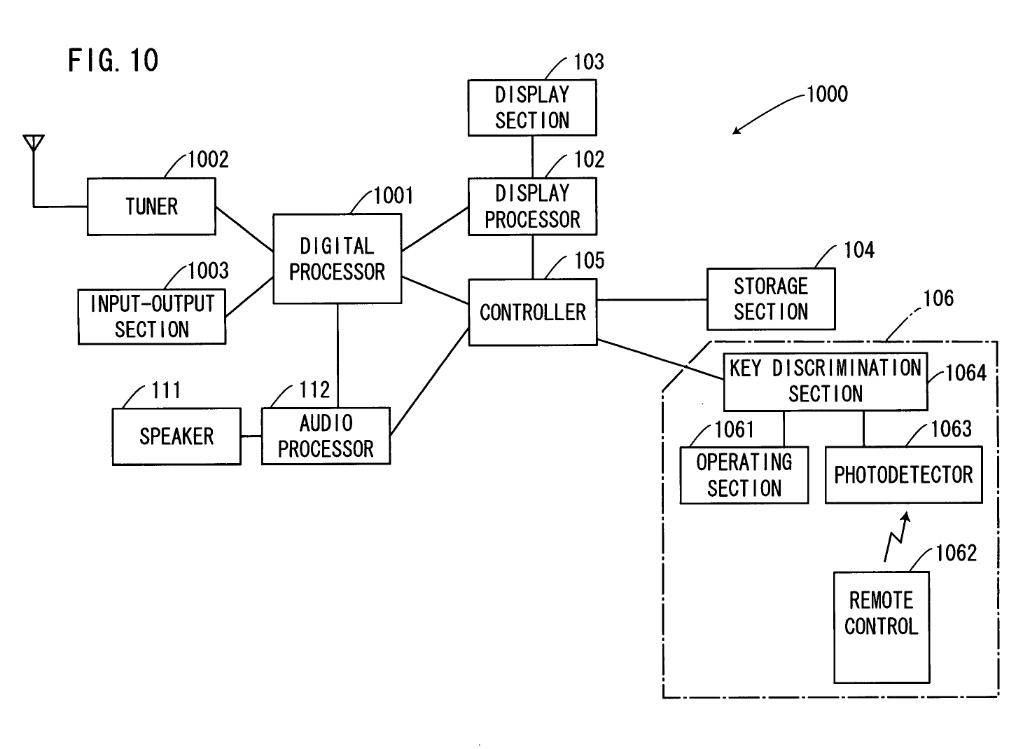

FIG. 10 is a block diagram showing the outline of a configuration relating to the invention of a television broadcast receiving apparatus constituting an interphone system according to this embodiment. In FIG. 10, the same components as those in the first embodiment (FIG. 1) are denoted by the same reference numerals and their description will be omitted or simplified here.

As shown in FIG. 10, a television 1000 of this embodiment includes a tuner 1002 capable of receiving digital broadcast signals, a digital processor 1001 which performs digital signal processing such as digital demodulation processing and decode processing compliant with the MPEG standard, a display processor 102, a display section 103, a storage section 104, a controller 105, an operating section 106, a speaker 111, an audio processor 112, and an input-output section 1003 which is a communication interface with an external apparatus.

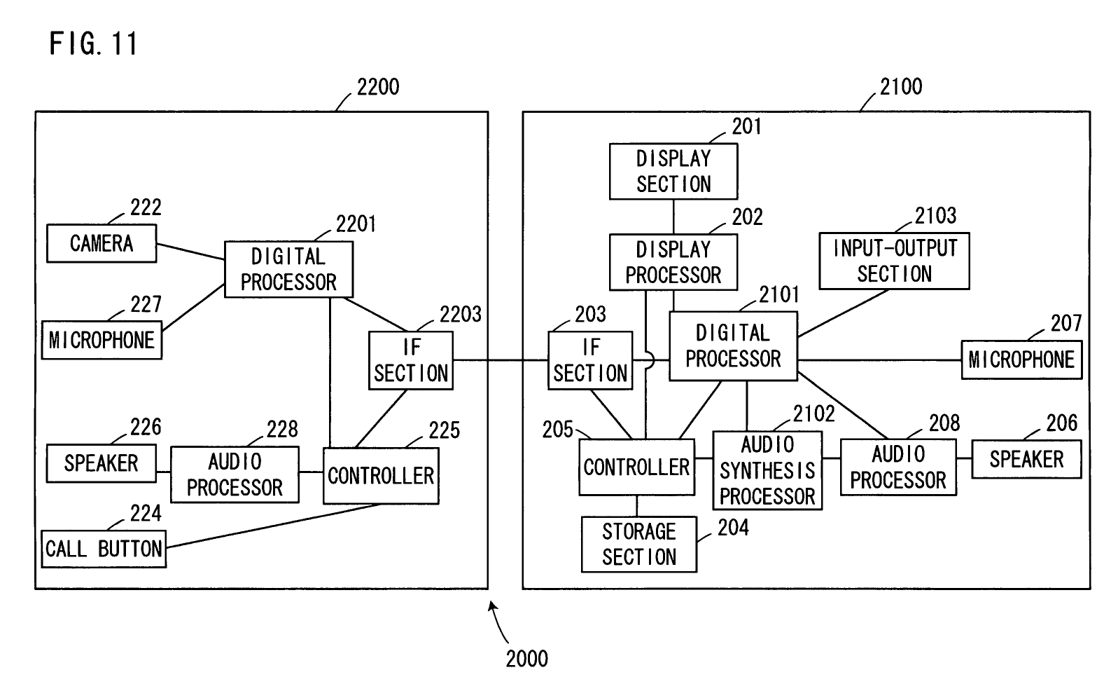

FIG. 11 is a block diagram showing the outline of a configuration relating to the invention of a door phone apparatus 2000 constituting the interphone system according to this embodiment. In FIG. 11, the same components as those in the first embodiment (FIG. 2) are denoted by the same reference numerals and their description will be omitted or simplified here.

A door phone master unit 2100 includes a display section 201, a display processor 202, an IF section 203 which is a communication interface with a door phone slave unit 2200, a storage section 204, a controller 205, a speaker 206, a microphone 207, an audio processor 208, an input-output section 2103 which is a communication interface with an external apparatus, a digital processor 2101 which performs digital signal processing such as digital demodulation processing and decode processing compliant with the MPEG standard, an audio synthesis processor 2102 which generates an audio signal from text data and the like. The door phone slave unit 2200 includes an IF section 2203 which is a communication interface with a door phone master unit 2100, a controller 225, a speaker 226, a microphone 227, an audio processor 228, a camera 222, a call button 224, and a digital processor 2201 which performs digital signal processing. In this embodiment, the IF section 203 of the door phone master unit 2100 is connected with the IF section 2203 of the door phone slave unit 2200 through wire.

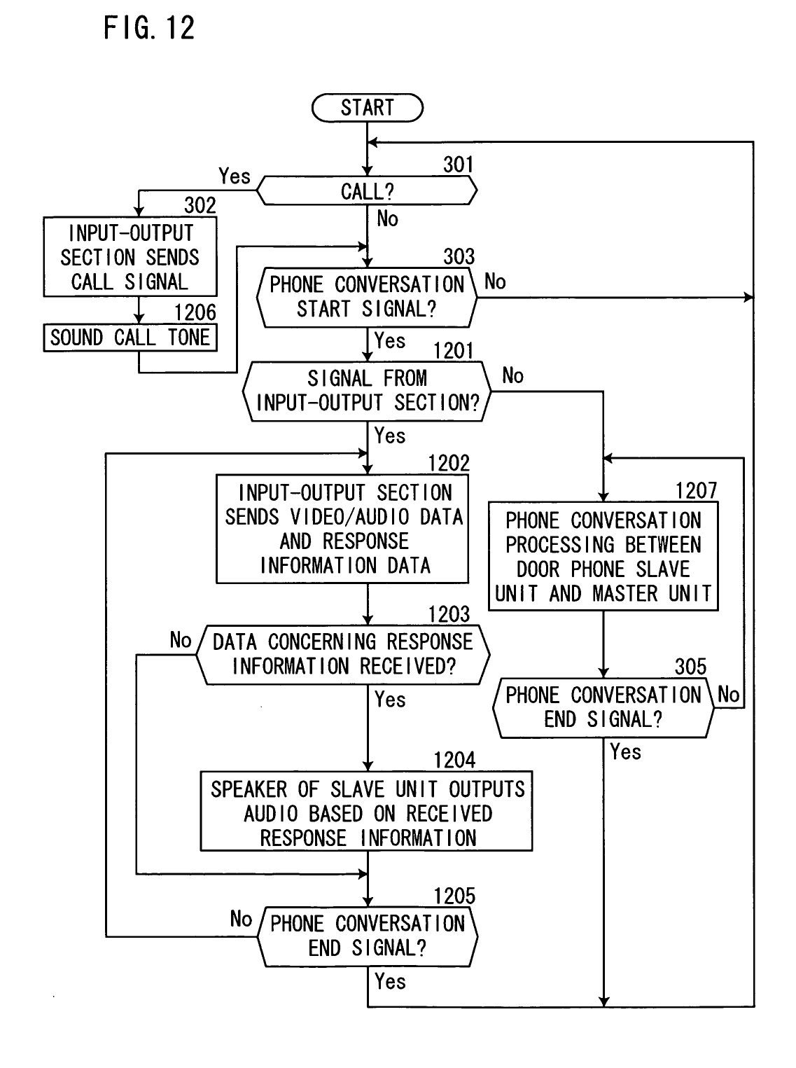

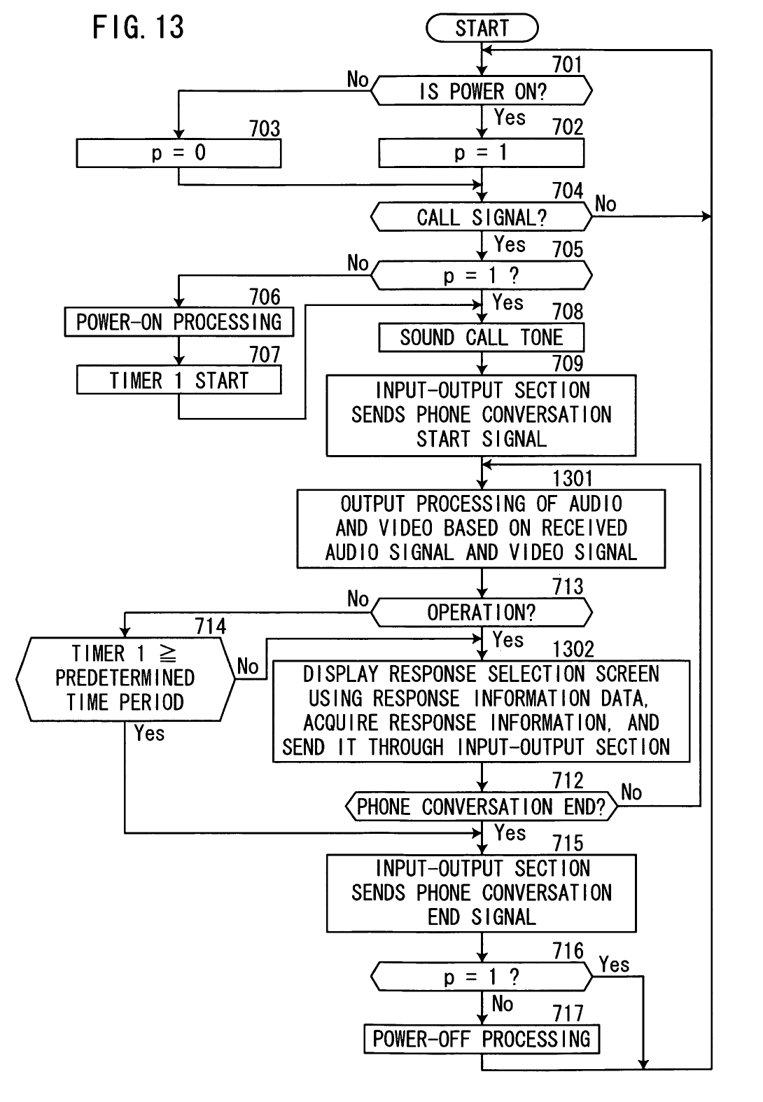

According to the configuration of the interphone system of this embodiment, the input-output section 1003 of the television 1000 and the input-output section 2103 of the door phone master unit 2100 are connected together by radio communication. The outline of operation relating to the invention of the interphone system having the above-mentioned configuration will be described with reference to FIGS. 12 and 13. FIG. 13 is a flowchart showing the outline of operation relating to the invention of the television 1000. In FIG. 13, the same processing concepts as those in the first embodiment (FIG. 6) are denoted by the same reference numerals and their description will be omitted or simplified here.

After receiving a “call signal” from the door phone apparatus 2000, the input-output section 1003 sends a “phone conversation start signal” (step 709). At the time of receiving video and audio signals from the door phone apparatus 2000 (described later), the digital processor 1001 performs digital demodulation and MPEG decoding on the received video and audio signals, and the display processor 102 and the audio processor 112 perform output processing on the decoded video and audio signals so that the television outputs the visitor's video and voice obtained by the door phone slave unit 2200 through the display section 103 and the speaker 111 respectively (step 1301).

In step 1302, the television 1000 displays a response selection screen (same as in FIG. 8) using “response information data” received from the door phone apparatus 2000, acquires response information selected by a user, and sends the response information (text data) from the input-output section 1003 to the door phone apparatus 2000. The processing concepts thereafter are the same as in the first embodiment (FIG. 6).

FIG. 12 is a flowchart showing the outline of operation relating to the invention of the door phone apparatus 2000. In FIG. 12, the same processing concepts as those in the first embodiment (FIG. 3) are denoted by the same reference numerals and their description will be omitted or simplified here.

If there is a “call” originated by a visitor (step 301), the input-output section 2103 sends a call signal (step 302) and the speaker 206 outputs a call tone such as “ding-dong” (step 1206). If there is a “phone conversation start signal” detected (step 303), it is determined whether or not the “phone conversation start signal” is inputted from the input-output section 2103 (step 1201). If the “phone conversation start signal” is not inputted from the input-output section 2103 (i.e., the “phone conversation start signal” is generated by the resident operating the door phone master unit 2100), the door phone slave unit 2200 and the door phone master unit 2100 perform phone conversation processing between themselves (step 1207 and step 305).

On the other hand, if the “phone conversation start signal” is inputted from the input-output section 2103 (i.e., the “phone conversation start signal” is sent from the television 1000), the digital processor 2101 digitally modulates video and audio data (which is obtained by MPEG-encoding (compressing) a video signal obtained from the camera 222 and an audio signal obtained from the microphone 227 at the digital processor 2201 in the door phone slave unit 2200) and response information data (which is stored in the storage section 204 as text data by setting in advance or by the user and is the same response information as in the first embodiment), and the input-output section 2103 sends the modulated data (step 1202). In the subsequent step 1203, it is determined whether or not the door phone apparatus 2000 has received “selected response information data” obtained by the user selecting from among the sent “response information data” through the television 1000. If the door phone apparatus 2000 has received “selected response information data”, the audio synthesis processor 2102 generates an audio signal from the selected response information (text data) and the speaker 226 of the door phone slave unit 2200 outputs the audio signal (subjected to signal processing as appropriate by the digital processor 2101 and the digital processor 2201) (step 1204).

As described above, according to the interphone system of this embodiment, “response information” is stored in the door phone apparatus 2000 side and sent to the television 1000 side as necessary, “selected response information” obtained by operating the television 1000 is sent to the door phone apparatus, and audio conversion processing is performed at the door phone apparatus 2000 based on the information.

### Third Embodiment

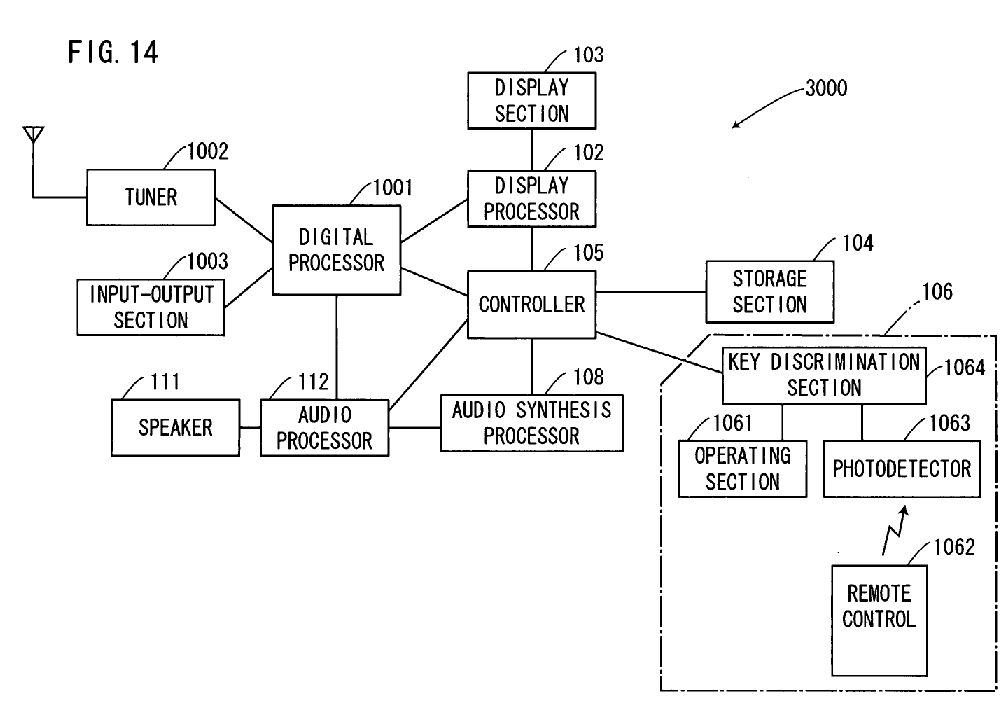

FIG. 14 is a block diagram showing the outline of a configuration relating to the invention of a television broadcast receiving apparatus constituting an interphone system according to this embodiment. In FIG. 14, the same components as those in the first embodiment (FIG. 1) or the second embodiment (FIG. 10) are denoted by the same reference numerals and their description will be omitted or simplified here.

A television 3000 of this embodiment includes a tuner 1002, a digital processor 1001, a display processor 102, a display section 103, a storage section 104, a controller 105, an operating section 106, an audio synthesis processor 108, a speaker 111, an audio processor 112, and an input-output section 1003.

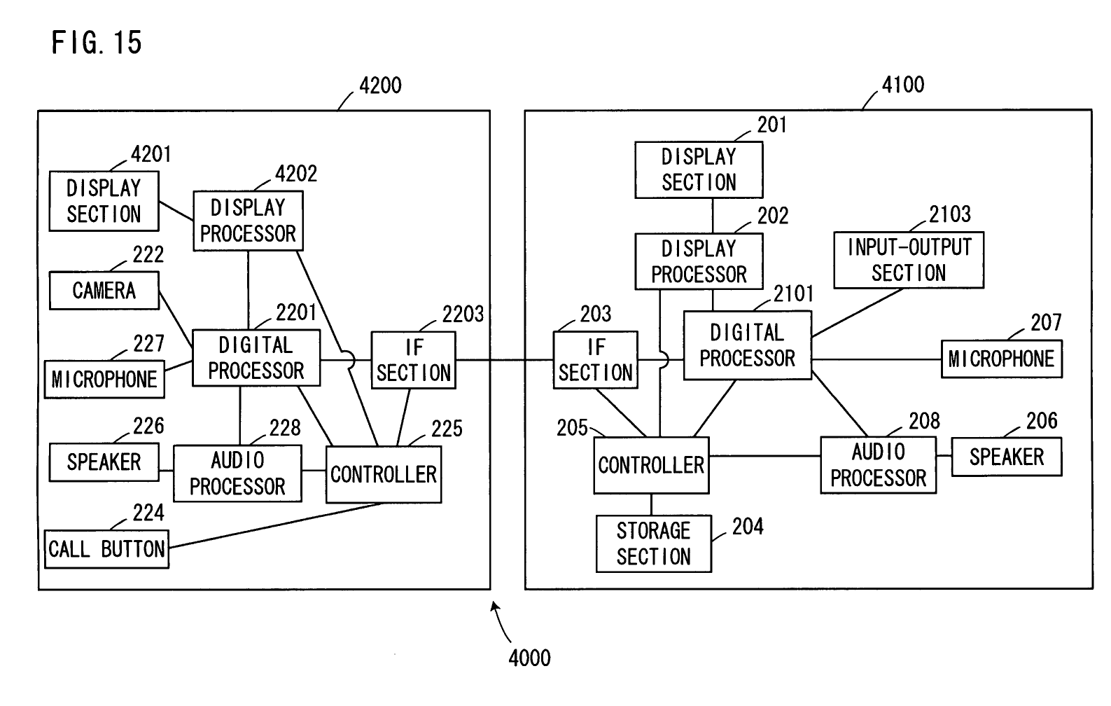

FIG. 15 is a block diagram showing the outline of a configuration relating to the invention of a door phone apparatus 4000 constituting the interphone system according to this embodiment. In FIG. 15, the same components as those in the first embodiment (FIG. 2) or the second embodiment (FIG. 11) are denoted by the same reference numerals and their description will be omitted or simplified here.

A door phone master unit 4100 includes a display section 201, a display processor 202, an IF section 203, a storage section 204, a controller 205, a speaker 206, a microphone 207, an audio processor 208, an input-output section 2103, a digital processor 2101. The door phone slave unit 4200 includes an IF section 2203, a controller 225, a speaker 226, a microphone 227, an audio processor 228, a camera 222, a call button 224, a digital processor 2201, a display section 4201, and a display processor 4202.

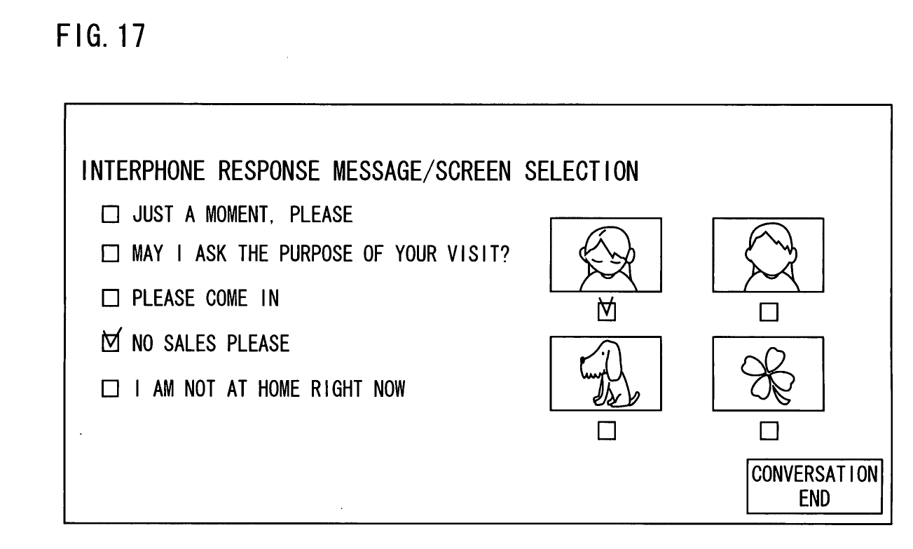

According to the configuration of the interphone system of this embodiment, the input-output section 1003 of the television 3000 and the input-output section 2103 of the door phone master unit 4100 are connected together by a cable. The operation concepts relating to the invention of the television 3000 are basically the same as in the first embodiment (FIG. 6). However, the storage section 104 of the television 3000 according to this embodiment stores video or images displayed on the display section 4201 of the door phone slave unit 4200 at the time of responding to a visitor (and also stores response text data as in the case of the first embodiment). In the response information acquisition processing of step 711, the television 3000 displays a response selection screen shown in FIG. 17 on the display section 103, acquires information about audio and video to be outputted from the door phone slave unit 4200, and sends the acquired information through the input-output section 1003 to the door phone apparatus 4000.

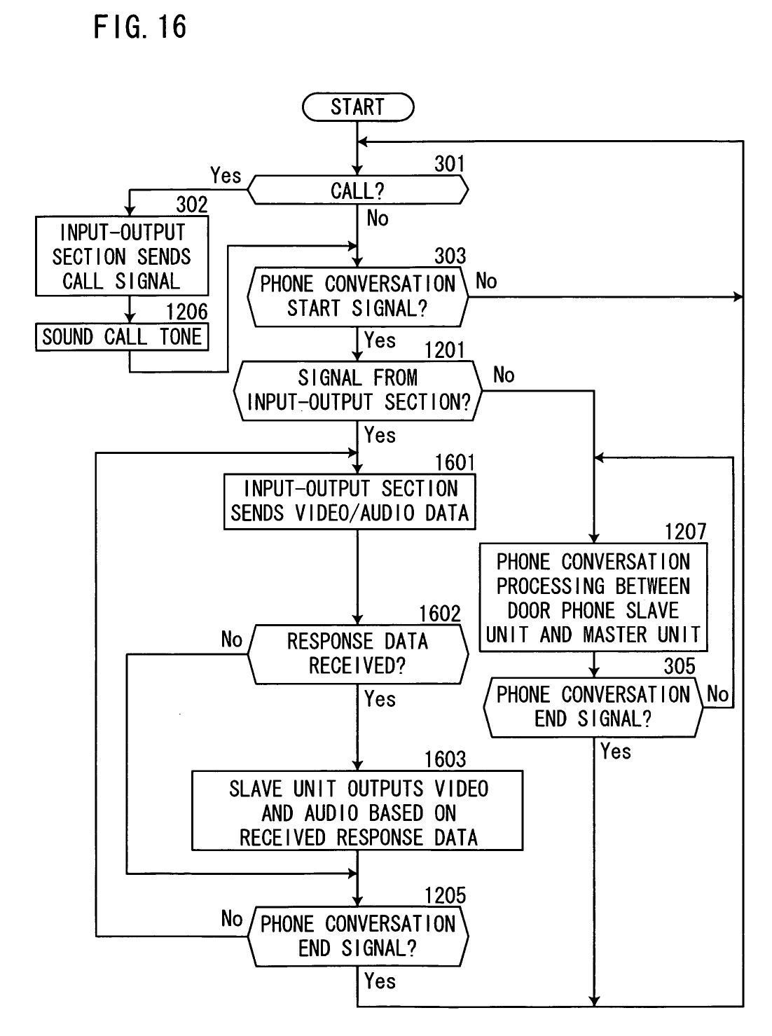

FIG. 16 is a flowchart showing the outline of operation relating to the invention of the door phone apparatus 4000. In FIG. 16, the same processing concepts as those in the first embodiment (FIG. 3) or the second embodiment (FIG. 12) are denoted by the same reference numerals and their description will be omitted or simplified here.

If a “phone conversation start signal” is inputted from the input-output section 2103 (i.e., the “phone conversation start signal” is sent from the television 3000), the digital processor 2101 digitally modulates video and audio data obtained by the door phone slave unit 4200, and the input-output section 2103 sends the modulated data (step 1601). If the door phone apparatus 4000 has received “response information (video and audio information)” from the television 3000 (step 1602), the display section 4201 and the speaker 226 of the door phone slave unit 4200 output video and audio corresponding to the response information (step 1603).

As described above, according to the interphone system of this embodiment, it is possible to allow the door phone slave unit to output video and response voice selected by the user, by only operating the remote control or the like of the television. Despite its mechanical response (response by mechanical voice) in a way, the system can show the resident's sentiment by changing response video etc. in accordance with a visitor, thus offering excellent convenience to the user.

Further, video or images as response information may be set arbitrarily by the user. For example, video or images inputted from an external apparatus (such as a record/playback apparatus) connected to the television can be captured and used as response information. The resolution and screen size of video or an image as response information may be converted into those according to the specification of the door phone slave unit before the video or image data is stored in the storage section. Alternatively, the resolution and screen size of the data may be converted when the data is sent to the door phone apparatus.

It should be understood by those skilled in the art that various modifications, combinations, sub-combinations and alterations may occur depending on design requirements and other factors insofar as they are within the scope of the appended claims or the equivalents thereof.

1. A television broadcast receiving apparatus which receives broadcast signals of different frequencies, the television broadcast receiving apparatus comprising:
an input section capable of receiving an audio signal and/or a video signal from a door phone apparatus including a door phone slave unit and a door phone master unit;
an audio processing section and/or a video display processing section;
a speaker;
a display section;
an output section capable of sending response information to the door phone apparatus; and
a storage section which stores response information inputted in advance or by a user,
wherein the audio processing section or the video display processing section allows the speaker or the display section to output audio or video at the time of receiving an audio signal or a video signal from the door phone apparatus, and the output section sends the response information stored in the storage section in response to the audio signal or the video signal from the door phone apparatus.

2. The television broadcast receiving apparatus according to claim 1, further comprising an operating section and an audio synthesis processing section, wherein the response information is set by the user operating the operating section, acquired as text data and stored in the storage section; and the response information that is sent as a response from the output section to the door phone apparatus is an audio signal into which the text data is converted by the audio synthesis processing section.

3. A door phone apparatus including a door phone slave unit and a door phone master unit, the door phone apparatus comprising:
a sending section capable of sending an audio signal or a video signal from the door phone slave unit having a microphone or a microphone and a camera to a television broadcast receiving apparatus according to claim 1; and
a receiving section capable of receiving response information sent from the television broadcast receiving apparatus,
wherein when the receiving section receives response information from the television broadcast receiving apparatus, a speaker provided in the door phone slave unit outputs audio corresponding to the response information.

4. An interphone system comprising a television broadcast receiving apparatus according to claim 1 and a door phone apparatus including a door phone slave unit and a door phone master unit, the door phone apparatus comprising:
a sending section capable of sending an audio signal or a video signal from the door phone slave unit having a microphone or a microphone and a camera to the television broadcast receiving apparatus; and
a receiving section capable of receiving response information sent from the television broadcast receiving apparatus,
wherein when the receiving section receives response information from the television broadcast receiving apparatus a speaker provided in the door phone slave unit outputs audio corresponding to the response information,
wherein an input section and an output section provided in the television broadcast receiving apparatus are respectively connected with a sending section and a receiving section provided in the door phone apparatus through wire or by radio; when there is an output of an audio signal or a video signal from a door phone slave unit, the door phone apparatus sends the audio signal or the video signal to the television broadcast receiving apparatus and the television broadcast receiving apparatus outputs audio or video based on the received audio signal or video signal; and when there is a response instruction provided from a user to the television broadcast receiving apparatus, the television broadcast receiving apparatus sends response information to the door phone apparatus and the door phone apparatus outputs audio based on the received response information through a speaker provided in the door phone slave unit.

5. A door phone apparatus including a door phone slave unit and a door phone master unit, the door phone apparatus comprising:
a sending section capable of sending an audio signal or a video signal from the door phone slave unit having a microphone or a microphone and a camera to a television broadcast receiving apparatus according to claim 1;
a receiving section capable of receiving response information sent from the television broadcast receiving apparatus; and
an audio synthesis processing section,
wherein when the receiving section receives response information from the television broadcast receiving apparatus, the audio synthesis processing section generates an audio signal based on the response information and a speaker provided in the door phone slave unit outputs audio corresponding to the audio signal.

6. An interphone system comprising a television broadcast receiving apparatus according to claim 1 and a door phone apparatus including a door phone slave unit and a door phone master unit, the door phone apparatus comprising:
a sending section capable of sending an audio signal or a video signal from the door phone slave unit having a microphone or a microphone and a camera to the television broadcast receiving apparatus;
a receiving section capable of receiving response information sent from the television broadcast receiving apparatus; and
an audio synthesis processing section,
wherein when the receiving section receives response information from the television broadcast receiving apparatus, the audio synthesis processing section generates an audio signal based on the response information and a speaker provided in the door phone slave unit outputs audio corresponding to the audio signal,
wherein response information stored in a storage section of the television broadcast receiving apparatus is text data; an input section and an output section provided in the television broadcast receiving apparatus are respectively connected with a sending section and a receiving section provided in the door phone apparatus through wire or by radio; when there is an output of an audio signal or a video signal from a door phone slave unit, the door phone apparatus sends the audio signal or the video signal to the television broadcast receiving apparatus and the television broadcast receiving apparatus outputs audio or video based on the received audio signal or video signal; and when there is a response instruction provided from a user to the television broadcast receiving apparatus, the television broadcast receiving apparatus sends text data that is the response information to the door phone apparatus and the door phone apparatus generates an audio signal based on the received text data through the audio synthesis processing section and outputs audio based on the audio signal through a speaker provided in the door phone slave unit.

7. A door phone apparatus including a door phone slave unit and a door phone master unit, the door phone apparatus comprising:
an audio synthesis processing section;
a storage section which stores response information inputted in advance or by a user; and
a data input-output section capable of inputting and outputting data from and to a television broadcast receiving apparatus,
wherein when there is an output of an audio signal or a video signal from the door phone slave unit, the data input-output section sends the audio signal or the video signal and a response instruction request; and when there is an instruction from the television broadcast receiving apparatus in response to the response instruction request, the audio synthesis processing section generates an audio signal based on the response information according to the instruction and a speaker provided in the door phone slave unit outputs audio corresponding to the audio signal.

8. A television broadcast receiving apparatus which receives broadcast signals of different frequencies, the television broadcast receiving apparatus comprising:
a data input-output section capable of inputting and outputting data from and to a door phone apparatus according to claim 7;
an audio processing section and/or a video display processing section;
a speaker;
a display section; and
an operating section,
wherein the audio processing section or the video display processing section allows the speaker or the display section to output audio or video at the time of receiving an audio signal or a video signal from the door phone apparatus, the video display processing section displays a response instruction request on the display section at the time of receiving the response instruction request, and when there is an instruction provided from a user to the operating section in response thereto, the data input-output section sends the instruction to the door phone apparatus.

9. An interphone system comprising a door phone apparatus according to claim 7 and a television broadcast receiving apparatus which receives broadcast signals of different frequencies, the television broadcast receiving apparatus comprising:
a data input-output section capable of inputting and outputting data from and to the door phone apparatus,
an audio processing section and/or a video display processing section;
a speaker;
a display section; and
an operating section,
wherein the audio processing section or the video display processing section allows the speaker or the display section to output audio or video at the time of receiving an audio signal or a video signal from the door phone apparatus, the video display processing section displays a response instruction request on the display section at the time of receiving the response instruction request, and when there is an instruction provided from a user to the operating section in response thereto, the data input-output section sends the instruction to the door phone apparatus,
wherein a data input-output section provided in the door phone apparatus is connected with a data input-output section provided in the television broadcast receiving apparatus through wire or by radio; when there is an output of an audio signal or a video signal from a door phone slave unit, the data input-output section sends the audio signal or the video signal and a response instruction request and the television broadcast receiving apparatus outputs audio or video based on the received audio signal or video signal and displays the response instruction request on the display section; and when there is an instruction provided from a user in response thereto, the television broadcast receiving apparatus sends the instruction to the door phone apparatus, and the door phone apparatus generates an audio signal based on response information through the audio synthesis processing section according to the received instruction and outputs audio based on the audio signal through a speaker provided in the door phone slave unit.

10. A door phone apparatus including a door phone slave unit and a door phone master unit, the door phone apparatus comprising:
a sending section capable of sending an audio signal or a video signal from the door phone slave unit having a microphone or a microphone and a camera to a television broadcast receiving apparatus according to claim 2; and
a receiving section capable of receiving response information sent from the television broadcast receiving apparatus,
wherein when the receiving section receives response information from the television broadcast receiving apparatus, a speaker provided in the door phone slave unit outputs audio corresponding to the response information.

11. An interphone system comprising a television broadcast receiving apparatus according to claim 2 and a door phone apparatus comprising:
a sending section capable of sending an audio signal or a video signal from the door phone slave unit having a microphone or a microphone and a camera to the television broadcast receiving apparatus; and
a receiving section capable of receiving response information sent from the television broadcast receiving apparatus,
wherein when the receiving section receives response information from the television broadcast receiving apparatus, a speaker provided in the door phone slave unit outputs audio corresponding to the response information,
wherein an input section and an output section provided in the television broadcast receiving apparatus are respectively connected with a sending section and a receiving section provided in the door phone apparatus through wire or by radio; when there is an output of an audio signal or a video signal from a door phone slave unit, the door phone apparatus sends the audio signal or the video signal to the television broadcast receiving apparatus and the television broadcast receiving apparatus outputs audio or video based on the received audio signal or video signal; and when there is a response instruction provided from a user to the television broadcast receiving apparatus, the television broadcast receiving apparatus sends response information to the door phone apparatus and the door phone apparatus outputs audio based on the received response information through a speaker provided in the door phone slave unit.
